(19) United States
(12) Patent Application Publication
(10) Pub. No.: US 2026/0302764 A1
(43) Pub. Date: Oct. 1, 2026

(54) SAFETY MODULE FOR AN ELECTRICAL DEVICE, AND METHOD FOR OPERATING SAME

(71) Applicant: Turck Holding GmbH, Halver (DE)

(72) Inventors: Michael Flesch, Jüchen (DE); Johannes vom Stein, Hückeswagen (DE)

(73) Assignee: Turck Holding GmbH, Halver (DE)

(21) Appl. No.: 19/679,952

(22) Filed: May 18, 2026

Related U.S. Application Data
(63) Continuation of application No. PCT/EP2024/083421, filed on Nov. 25, 2024.

(30) Foreign Application Priority Data
Nov. 28, 2023 (DE) 10 2023 133 162.0

(51) Int. Cl. H02H 7/22

(52) U.S. Cl. CPC H02H 7/22

(57) ABSTRACT

A safety module for an electrical device comprises a device power input configured to be electrically connected to an electrical distribution apparatus; a device power output configured to be connected to the electrical device; a switching module configured to switch an electrical connection between the device power input and the device power output; a device safe logic module configured to drive the switching module; and a device interface configured to establish a data-technological connection of the device safe logic module to the electrical distribution apparatus; wherein the device safe logic module is configured to monitor a switching state of the switching module and, when a fault state of the switching module occurs, to send a disabling signal via the device interface to the electrical distribution apparatus.

### CROSS REFERENCE TO RELATED APPLICATIONS

This application is a continuation application of international patent application PCT/EP2024/083421, filed on Nov. 25, 2024, and designating the U.S., which claims priority to German patent application 10 2023 133 162.0, filed on Nov. 28, 2023, each of which are hereby incorporated by reference in their entireties.

### TECHNICAL FIELD

The present disclosure is in the technical field of industrial automation. The present disclosure can relate to a safety module for an electrical device and to a method for operating a safety module. It furthermore can relate to an electrical device, to an electrical distribution apparatus, to a system and to a method for operating an electrical device, the electrical distribution apparatus or the system.

### BACKGROUND

To protect against injury or damage in automation technology, a high safety level is required. For applications in which the deenergized state is the “safe state”, reliable voltage disabling must be provided. A so-called simple fault, in which a disabling path does not function, must not lead to loss of the safety function. A simple fault occurs, for example, when mechanical contacts become welded and then can no longer be opened or when transistor switches fail and can no longer be switched off. Redundant disabling paths are therefore provided. Furthermore, optionally, provision is made to diagnose a simple fault.

For example, it is known to equip a fieldbus module with a communication port that can be securely disabled. Furthermore, for example, according to the guidelines of the specification “IO-Link Safety System Extensions with SMI, V1.1.3, March 2022” an FS master may be connected to an FS device, where “FS” stands for functional safety. Both have a safe logic, typically consisting of two microcontrollers, which test all safety-relevant data in a cross-comparison. A disabling command can then be given securely to the FS device and secure disabling can take place via two disabling components. Since an IO-Link safety SDCI class B port itself already has a voltage supply with a high safety level, in such a structure there are four disabling components in series. This is associated with great outlay.

DE 10 2020 112 985 A1 describes an IO-Link adapter, which is arranged between a master and a device. DE 10 2021 114 855 A1 proposes an industrial plant having a safety switching device. DE 10 2020 007 808 A1 relates to a safety disabling apparatus for a mechatronic component to provide a secure emergency stop function.

### SUMMARY

A safety module for an electrical device comprises a device power input configured to be electrically connected to an electrical distribution apparatus; a device power output configured to be connected to the electrical device; a switching module configured to switch an electrical connection between the device power input and the device power output; a device safe logic module configured to drive the switching module; and a device interface configured to establish a data-technological connection of the device safe logic module to the electrical distribution apparatus; wherein the device safe logic module is configured to monitor a switching state of the switching module and, when a fault state of the switching module occurs, to send a disabling signal via the device interface to the electrical distribution apparatus.

A distribution apparatus for providing a voltage supply for at least one electrical device, comprises a master power output; at least one disabling component configured to disconnect the master power output; a master safe logic module configured to drive the disabling component; and a master interface configured for data-technological connection of the master safe logic module to a safety module assigned to the electrical device; wherein the master safe logic module is configured to drive the disabling component when a disabling signal is received so that the master power output is disconnected.

A method comprises operating a system having an electrical device which is coupled for voltage supply via a safety apparatus to a distribution apparatus; wherein operating the system includes switching a voltage supply via the safety apparatus; monitoring a switching state of the safety apparatus; and, when a fault state occurs, sending a disabling signal to the distribution apparatus causing the distribution apparatus to switch (optional turn off) the voltage supply.

### BRIEF DESCRIPTION OF THE DRAWINGS

In the drawings:

FIG. 1 shows a wiring diagram of a first exemplary optional implementation of the system having a distribution apparatus and a safety module;

FIG. 1A shows a diagram of an example method for operating the system;

FIG. 1B shows a further diagram of the example method for operating the system;

FIG. 2 shows a wiring diagram of a second exemplary optional implementation of the system having a distribution apparatus and a safety module; and

FIG. 3 shows a wiring diagram of a third exemplary optional implementation of the system having a distribution apparatus and a safety module.

### DESCRIPTION

In the following, details are set forth to provide a more thorough explanation of the disclosure. However, it will be apparent to those skilled in the art that these implementations may be practiced without these specific details. In other instances, well-known structures and devices are shown in block diagram form or in a schematic view rather than in detail to avoid obscuring the disclosure. In addition, features described hereinafter may be combined with each other, even if described with respect to different figures, unless specifically noted otherwise.

Equivalent or like elements or elements with equivalent or like functionality are denoted in the following description with equivalent or like reference numerals. As the same or functionally equivalent elements are given the equivalent or like reference numbers in the figures, a repeated description for elements provided with the equivalent or like reference numbers may be omitted. Hence, descriptions provided for elements having the equivalent or like reference numbers are mutually exchangeable.

Directional terminology, such as “top,” “bottom,” “below,” “above,” “front,” “behind,” “back,” “leading,” “trailing,” etc., may be used with reference to the orientation of the figures being described. Because parts of the disclosure, described herein, can be positioned in a number of different orientations, the directional terminology is used for purposes of illustration and is in no way limiting. It is to be understood that other implementations may be utilized, and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

The terms “substantially” and “approximately” may be used herein to account for small manufacturing tolerances (e.g., within 5%) that are deemed acceptable in the industry without departing from the aspects of the implementations described herein. For example, a resistor with an approximate resistance value may practically have a resistance within 5% of that approximate resistance value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

Redundant disabling components can entail more outlay, additional costs, more space requirement and a power loss.

One possible object of the disclosure can be to provide a safety module for an electrical device, optionally a field device, for instance an actuator, or a device for supplying a further device with a working voltage, a system and a method for operating a safety module, with which the aforementioned disadvantages can be overcome and, optionally, a reliable disabling ability is provided simply and cost-efficiently.

Accordingly, the object is achieved by a safety module for an electrical device. The electrical device may optionally be a field device, for example a sensor or actuator for industrial automation. The safety module comprises a device power input for electrical attachment to an electrical distribution apparatus and a device power output for attaching the electrical device. It furthermore comprises a switching module for switching an electrical connection between the device power input and the device power output, as well as a device safe logic module for driving the switching module. It also comprises a device interface for data-technological connection of the device safe logic module to the distribution apparatus. The device safe logic module is adapted to monitor a switching state of the switching module and, in the event of a fault state of the switching module, to send a disabling signal via the device interface.

The safety module may be integrated into the electrical device or configured separately.

In one optional implementation, the device interface is configured to establish an IO-Link connection, optionally to establish an IO-Link communication connection between the distribution apparatus and the safety module and/or to connect an IO-Link voltage supply of the distribution apparatus to the electrical device.

The electrical device may, for example, be configured as an IO-Link device which is attached to an IO-Link master and is data-technologically connected thereto. In this case, the power supply of the electrical device may furthermore take place via the IO-Link master.

When, below, in analogy with IO-Link terminology, the electrical device and the safety module are referred to as a “device” and the distribution apparatus is referred to as a “master”, this is not intended to imply any restriction to devices in accordance with the specifications of IO-Link except when this is explicitly made clear. Rather, it means that the electrical device as a “device” is dependent on the voltage supply by the distribution apparatus as a “master” the device is to this extent subordinate to the master. It may nevertheless also be employed in different architectures, which are likewise intended to be covered by the disclosure.

Optionally, the distribution apparatus may provide a “Class A” or “Class B” supply. Here, particularly in IO-Link terminology, “Class A” relates to a supply of the electrical device with a maximum power consumption of 200 mA at 24 V DC (direct current) while “Class B” relates to an electrical supply with a higher maximum power consumption, optionally to 400 mA at 24 V.

The “distribution apparatus” is to be understood broadly according to the present description as an apparatus by means of which an electrical voltage, or an electrical power, can be provided for the electrical device.

The distribution apparatus may in turn be attached to an external voltage supply, and in this way undertake “distribution” of the electrical power that it receives to one or more attached electrical devices.

Optionally, the distribution apparatus is configured so that it has a data-technological connection to attached electrical devices and is also capable of switching, and if appropriate isolating, the supply of the electrical device via the device power input of the safety module.

The device interface is to be understood optionally as a device-side interface, by means of which a data-technological connection to the distribution apparatus can be established.

A “device interface” may be understood as all or some of the pins of an attachment for a cabled connection, for example “Pin 1”, “Pin 3” and/or “Pin 4” in the case of IO-Link. Furthermore, a voltage supply of the safety module may also take place via the device interface, optionally via “Pin 1” and “Pin 3”.

In one optional implementation of the disclosure, a voltage supply of the device safe logic takes place DC-isolated or galvanically isolated from the device power input. Optionally, there is in this case DC isolation between a logic supply voltage and a “Class B” supply, that is to say there is no electrical connection between these two voltage potentials.

Optionally, the voltage supply of the safety module takes place isolated from a voltage supply of the electrical device, optionally a “Class B” supply, for which in IO-Link for instance “Pin 2” and “Pin 5” are provided and then correspond to the pin allocation at the device power input and device power output.

The device interface may furthermore be configured so that the voltage supply of the device safe logic module takes place through it. In this case, the voltage supply of the device safe logic module optionally takes place in addition to the data-technological connection to the distribution apparatus.

In one development, the safety module has at least one optocoupler, inductive coupler and/or capacitive coupler. Optionally, DC isolation is thereby produced between a potential applied to the device power input and a potential for the voltage supply of the device safe logic module.

The device safe logic module is optionally configured as a device-side instrument, by means of which data-technological signals can be received and sent. The device safe logic module undertakes on the device side the monitoring of the switching state of the device-side switching module. The device safe logic module may furthermore be configured so that it can also drive the switching module by itself.

The device safe logic module can identify a fault state of the switching module and, on the basis thereof, send a control signal which is transmitted as an (emergency) disabling signal to the distribution apparatus, where it causes disabling of the voltage supply of the electrical device. That is to say, when the device safe logic module identifies that the switching module is not causing, or is only insufficiently causing the (device-side) disabling of the voltage supply, it can induce the disabling to take place on the master side. The device safe logic module thus implements a redundancy in the disabling and therefore improved safety.

To monitor the switching module, the device safe logic module acquires optionally a setpoint switching state, or a switching requirement, and an actual switching state. By a comparison, it identifies whether they correspond to one another or whether there is a fault state in which disabling has not been carried out even though it is required.

In one optional implementation, the device-side switching module comprises a semiconductor switch and/or a relay switch and/or a contactor and/or a mechanical switch with a positively driven contact. This can provide reliable switching.

Floating contacts may optionally also be produced by means of optocouplers and relays. Optionally, the floating contacts are part of the device power output.

In a further optional implementation, the switching module has precisely one disabling path. In this case, the safety module is not configured with redundant disabling paths, redundancy instead being achieved in that the device safe logic module ensures disabling by means of a disabling path of the distribution apparatus if a fault situation is identified.

Furthermore, a feedback path may be provided for the switching state of the switching module. In this way, optionally, simple acquisition of the existing switching state is achieved.

The disclosure also relates to a method for operating the safety module, in which an electrical connection between a device power input and a device power output of the safety module can be switched, the switching state furthermore being monitored and an (emergency) disabling signal being sent in the event of a fault state.

The disclosure furthermore relates to an electrical device having a safety module according to the description above. Optionally, the safety module is integrated into the electrical device so that the voltage supply of the electrical device takes place directly via the device power input of the safety module.

The distribution apparatus, optionally as a superordinate device, for example an “IO-Link master”, includes a master power output. A voltage supply is provided optionally indirectly via a safety module according to the present description, which may for example be integrated into the electrical device. The master power output is, for example, adapted to attach the electrical device indirectly or directly thereto, optionally via the safety module. The distribution apparatus has at least one disabling component by which the master power output can be disconnected, or by which the electrical device can be isolated from the voltage supply. The distribution apparatus furthermore has a master safe logic module for driving the disabling component, as well as a master interface for the data-technological connection of the master safe logic module to a safety module, which is assigned to the electrical device. The master safe logic module is adapted so that when a disabling signal is received, optionally when a disabling signal is received via the master interface, the disabling signal being sent for example by a device “safety logic” module, it drives the disabling component in such a way that the master power output is disconnected, or the electrical device is isolated from the voltage supply.

The distribution apparatus is, optionally, configured to interact with a safety module as described here, or with an electrical device having such a safety module, while providing mutually redundant supplementary disabling paths.

The distribution apparatus may furthermore have its own attachment for an external voltage supply.

Optionally, the master interface is furthermore configured so that the safety module, or the device “safety logic” module, can be supplied with electrical power via this interface. Such a voltage supply for the device logic may, for example, take place in the IO-Link specification via “Pin 1” and “Pin 3”.

In an optional implementation of the distribution apparatus according to the IO-Link specifications supply, for example, a “Class B” supply is implemented for the attached electrical device. A supply of the “safety logic” module of the safety module may furthermore take place independently thereof and DC-isolated.

That is to say, the “Class B” supply for the electrical device may be interrupted without simultaneously also ending the data-technological communication connection to the safety module. The data connection may thus continue to exist, and it is for example also possible to transmit a signal for resuming the voltage supply and restarting the supply voltage on the side of the supply apparatus via the data connection.

The disclosure also relates to a method for operating the distribution apparatus, in which a voltage supply for at least one electrical device is provided and a master power output can be disconnected. When a disabling signal is received, the disabling component is driven so that the master power output is disconnected.

The disclosure also relates to a system having a supply apparatus and a safety module, which is coupled to the supply apparatus, for an electrical device, wherein the supply apparatus and the safety module are configured according to the present description.

The system accordingly has the same advantages and effects as described here. It may furthermore be developed in the ways described here.

Optionally, the disclosure can produce redundant disabling of the electrical device with the fewest possible disabling components. Optionally, a high safety level is obtained compared to the known solution despite a reduced number of disabling components placed in series.

Optionally, therefore, a safety application for secure voltage disabling is proposed, for example in the context of an “IO-Link safety” application. Optionally, only one single first disabling route is provided on the side of the device. If this first disabling route fails in the event of a serious fault, that is say if no disabling option is available any longer in the device and if this is identified by a diagnosis feature, the second disabling option on the side of the master device may then be resorted to. A high level of functional safety is therefore achieved.

Optionally, in a master device suitable for IO-Link, a voltage supply for attached devices via the terminals “Pin 2” and “Pin 5” may be disabled. By this being done in a safety-relevant fashion with one channel in the master device, a second disabling path may be used for a device. Since there is still a communication connection to the master device if the device-side disabling fails, secure disconnecting of the voltage supply of the device can be provided by means of this secure communication.

Optionally, the voltage disabling for the electrical device is carried out without all the lines of a port having to be isolated. In this way, further functions produced via further pins are not necessarily also disabled. For example, a communication connection may continue to be provided via further pins of a port.

In the method for operating a system having an electrical device which is coupled for the voltage supply via a safety apparatus to a distribution apparatus, a voltage supply can be switched via the safety apparatus. A switching state of the safety apparatus is monitored, this monitoring taking place optionally on the part of a safety module of the electrical device. In the method, furthermore, in the event of a fault state which exists particularly when it has not been possible to carry out desired disabling, a disabling signal by which the voltage supply is switched on the part of the distribution apparatus is sent to the distribution apparatus.

The method is configured, optionally, to operate the system described above. It therefore has the corresponding advantages and effects, and it may be developed in the corresponding way.

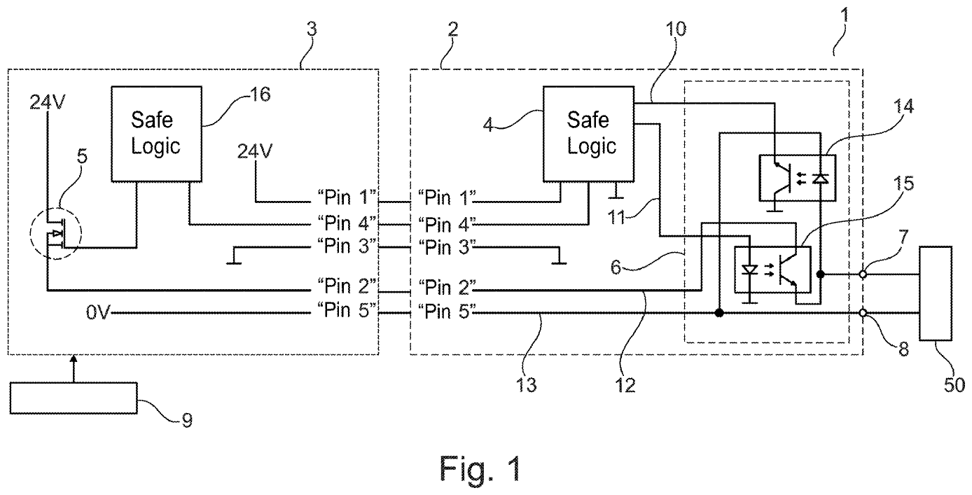

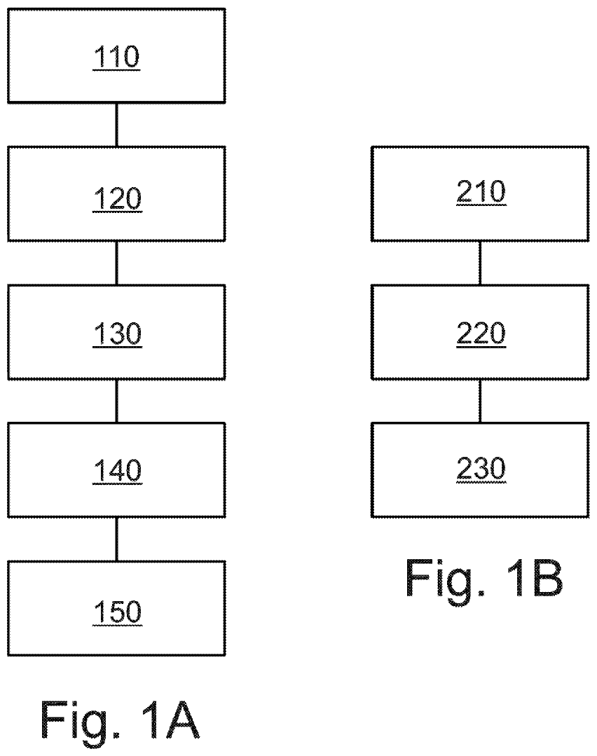

With reference to FIG. 1, a wiring diagram of a first exemplary implementation of the system having a distribution apparatus and a safety module is explained.

In the first exemplary implementation, the system 1 comprises a safety module 2 and a distribution apparatus 3.

Between the safety module 2 and the distribution apparatus 3, in the example there is an IO-Link connection in which the distribution apparatus 3 functions as an FS master. The safety module 2 in the exemplary implementation is part of an electrical device 50, which in the example is operated as an FS device 50.

The IO-Link connection is established via five cable attachments, which are denoted on both sides according to the IO-Link specification as “Pin 1”, “Pin 2”, “Pin 3”, “Pin 4” and “Pin 5”.

The distribution apparatus 3 has an attachment to an external voltage source 9.

In the IO-Link connection between the supply apparatus 3 and the safety module 2, the terminals “Pin 2” and “Pin 5” are assigned to a “Class B” voltage supply for the device attached as an FS device 50.

The supply apparatus 3 furthermore has a disabling component 5, with which optionally the terminal “Pin 2” for the voltage supply can be disconnected.

The disabling component 5 is coupled to a master safe logic module 16 and can be controlled via the latter. Optionally, a signal may be transmitted via the master safe logic module 16 to the disabling component 5, which leads to opening of an electrical connection of the disabling component 5 and therefore to disabling of the voltage supply via the terminals “Pin 2” and “Pin 5”.

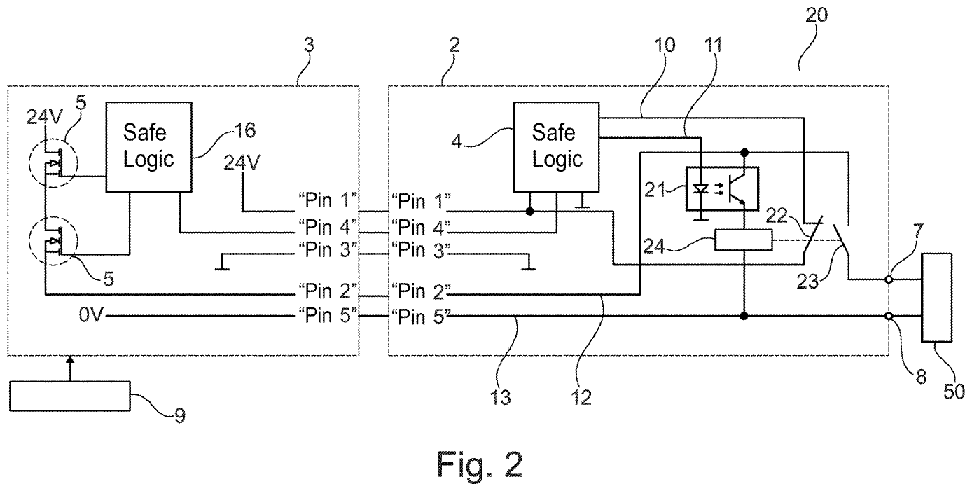

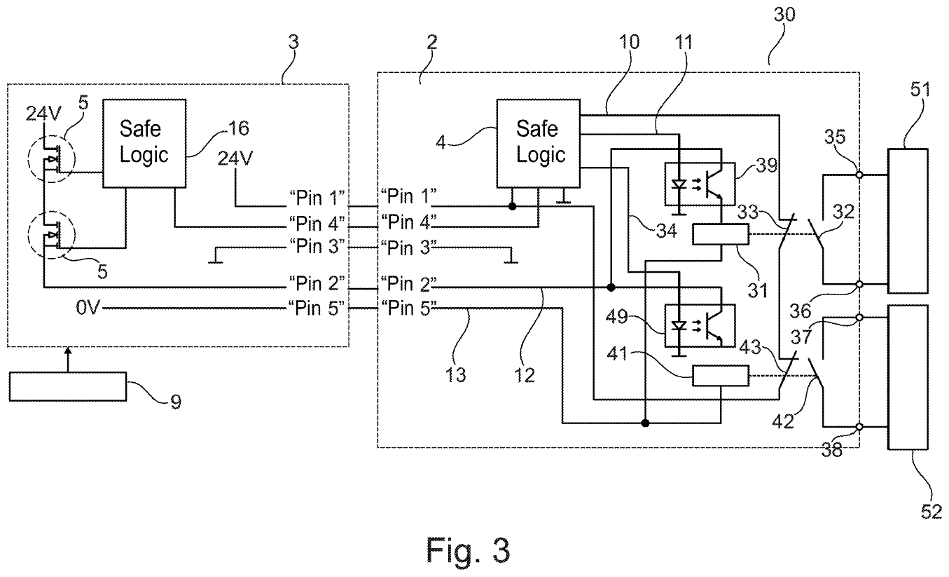

In further exemplary implementations, the disabling component 5 of the supply instrument may be duplicated, that is to say present redundantly, for instance in the examples shown in FIG. 2 and FIG. 3. The disabling components 5 shown there can likewise be driven via the master safe logic module 16. This double optional implementation is not, however, necessary since the required redundancy—as is explained below—can be obtained by the interplay with the switching module 6 of the safety module 2.

In the example, the safety module 2 is considered to be part of the electrical device 50.

The safety module 2 has a positive output pin 7 and a negative output pin 8, via which the electrical device 50 is provided with a “Class B” voltage supply.

In the example, the negative output pin 8 is connected via a line 13 to the terminal “Pin 5”, which is at a potential of 0 V. The line 13 is thus optionally connected to the negative pole of the “Class B” voltage supply. The positive output pin 7 is connected via a line 12 to the terminal “Pin 2”, which is at a potential of 24 V. The line 12 is thus optionally connected to the positive pole of the “Class B” voltage supply.

Furthermore, a first optocoupler 15 is arranged in the line 12 to the positive output pin 7. It is used as a switching element and is connected via an output drive line 11 to a device safe logic module 4 of the safety module 2.

When a signal for disabling is received by the output drive line 11, the first optocoupler 15 interrupts the flow of current through the line 12.

A line branching off from the line to the positive output pin 7 forms a feedback path, which is connected via a second optocoupler 14 to the line 13 of the negative output pin 8. So long as the potential of the positive output pin 7 is not equal to 0 V, as with the negative output pin 8, a signal can be acquired via the second optocoupler 14 as feedback via a line 10.

That is to say, feedback relating to the existing switching state of the switching module 6 is received by the second optocoupler.

In the example, the elements for switching the “Class B” supply via the terminals 7, 8 of the safety module 2 are combined in a switching module 6.

Furthermore, the terminals “Pin 1” and “Pin 3” are assigned to a voltage supply for the device safe logic module 4. That is to say, the distribution apparatus supplies the device safe logic module 4 with electrical power via the terminals “Pin 1” and “Pin 3”. This power supply is not affected when the “Class B” supply via the terminals “Pin 2” and “Pin 5” is disabled, that is say a data connection can continue to be operated even after disabling of the electrical device 50.

In other words, the electrical device 50 has only one single device-side disabling path with the safety module 2, which is configured for example as an “IO-Link safety” FS device 2. The safety module 2 securely detects a fault state in the event of disabling.

Furthermore, the FS master 3 comprises a master safe logic module 16 and at least one disabling component 5, optionally a plurality of disabling components 5. The ability to securely disable the “Class B” supply at “Pin 2” (P24) and “Pin 5” (N24) is now monitored. For this purpose, a disabling component 5 may also release the 0 V path (N24).

In addition, further feedback and monitoring electronics (not represented) may be provided.

The FS master 3 is supplied with voltage by the external voltage supply 9.

An interface from the FS master to the FS device contains two terminals (“Pin 1”, “Pin 3”), via which optionally a device safe logic module 4 is supplied with voltage, as well as a terminal for the serial communication (“Pin 4”) and two further terminals (“Pin 2”, “Pin 5”) for the voltage supply of an attached electrical device, optionally a “Class B” supply.

The FS device 2 thus likewise has a safe logic module 4.

The master safe logic module 16 and the device safe logic module 4 both have a redundant structure, at least with a redundant ALU (arithmetic logic unit), and typically with a redundant MCU (micro processing unit) and a redundant memory (random-access memory, RAM; read-only memory, ROM).

All safety-relevant data are on the one hand processed redundantly and on the other hand checked by a cross-comparison.

The FS device 2 is supplied with a logic voltage by the FS master 3, specifically via the terminals “Pin 1” and “Pin 3”.

Furthermore, the FS device 2 has at least one drive path 11 with which a digital output is driven, as well as at least one feedback path 10 with which the driving of the output is monitored.

One essential feature of the FS device 2 is that it has DC isolation between the logic supply voltage and the “Class B” supply. That is to say, there is no electrical connection between these two voltage potentials.

Due to a fault of some kind on the logic side, it may be possible that switching on of the output does not take place when the “Class B” supply is disabled.

During operation of the system 1, the output may now be enabled via the following method, which is schematically shown in FIG. 1A.

In a first step 110, the “Class B” supply is switched on.

In a further step 120, the fact that no voltage is applied to the output terminal 7 is acquired via feedback of the feedback channel 10 of the safety module 2.

In a further step 130, a drive command that the output should be enabled is transmitted from the FS master 3 to the FS device 2.

In a further step 140, on the device side, the output is switched on via the drive line 11.

In a further step 150, the fact that the output is switched on is then acquired with the aid of the feedback channel 10.

During operation of the system 1, in order to operate an output, whether the output can be disabled may be cyclically tested. For example, it may be disabled cyclically for a short time by means of a drive command via the drive line 11, or/and the “Class B” supply may be cyclically switched off for a short time, successful disabling of the output being monitored via the feedback channel 10 in the enabled and off states.

An example of the method then used for disabling in a fault situation is schematically shown in FIG. 1B.

In a first step 210, it is established that the actual state, which is acquired via the feedback line 10, does not correspond to the SETPOINT state of the switching module 6. That is to say, the output terminals 7, 8 are not isolated from the voltage supply even though a corresponding state has been driven.

In a further step 220, a command for emergency disabling is transmitted from the safe logic module 4 of the FS device 2 to the safe logic module 4 of the FS master 3.

In a further step 230, the FS master 3 disables the “Class B” supply via the redundant disabling components 5 so that the electrical device 50 attached via the safety module 2 is also no longer connected to the “Class B” supply.

In the example shown in FIG. 1, only one path for disabling is thus respectively provided in the master 3 and in the device 2. The diagnosis feature now makes it possible to perform the disabling securely and redundantly even at relatively high powers.

In this way, the costs for individual electrical devices 2, 3, 50 can be reduced but at the same time a high safety level is obtained.

The electrical device 50 may optionally comprise an actuator or another standard module, in which case the secure disabling may be produced in many standard modules to obtain the required safety levels by the interplay between the master and the device.

It is of particular importance for the safety module that the DC-isolated lines for the voltage supply of the device safe logic module 4 and for the “Class B” supply are provided. This is done in the example shown in FIG. 1 via a digital output having an optocoupler.

The safety module 2 has a first optocoupler 15 and a second optocoupler 14. Via the optocouplers 14, 15, DC isolation is achieved between two disabling paths. In further exemplary implementations, the DC isolation may alternatively or in addition be produced by inductive couplers or capacitive couplers.

The first optocoupler 15 is driven by a drive signal via the line 11, and it switches a “Class B” potential via the line 12 through to the output terminal 7 of the safety module 2.

The second optocoupler 14 feeds the ACTUAL state of the output terminal 7 back to the device safe logic module 4 of the safety module 2.

The device safe logic module 4 monitors the switching state by comparing the ACTUAL state with the SETPOINT state.

If it is then registered that it has not been possible to carry out disabling of the “Class B” supply successfully, the safe logic module 4 of the safety module 2 transmits a signal to the FS master 3, by which the latter is induced to disable the “Class B” supply via the terminal “Pin 2”.

A plurality of interconnections of the switching module 6 may be provided in an FS device 2, each of which has a drive line 11 and a feedback path 10 as well as an output terminal 7, but in which the “Class B” supply 12, 13 is delivered in parallel.

The terminals of the supply apparatus 3 are allocated as follows:
“Pin 1” as “L+” with a voltage of 24 V”,
“Pin 3” as “L−” with a voltage of 0 V” and
“Pin 4” as “Q/C and SDCI-FS”.

The “Class B” supply is provided by the terminals:
“Pin 2” as “P24” with a voltage of 24 V” and
“Pin 5” as “N24” with a voltage of 0 V”.

The allocation is configured correspondingly on the device side:
“Pin 1” as “L+” with a voltage of 24 V” and
“Pin 3” as “L−” with a voltage of 0 V” as well as
“Pin 4” connected to the line for “Q/C and SDCI-FS”

The attachment to the “Class B” voltage supply takes place via the terminals “Pin 2” and “Pin 5”.

With reference to FIG. 2, a wiring diagram of a second exemplary implementation of the system having a distribution apparatus and a safety module is explained. This is based on the description above of the first exemplary implementation, and elements which are similar or have the same effect, or are structurally and/or functionally comparable, are provided with the same references. The differences between the exemplary optional implementations are primarily discussed below.

In the second exemplary optional implementation of a system 20, a mechanical contact as well as feedback via a positively driven breaker are provided.

An IO-Link takes place with a relay contact.

The DC isolation takes place in this exemplary implementation via an optocoupler 21 and floating contacts of a relay 24. The optocoupler 21 is driven by a drive signal 11 and excites the relay 24.

A floating contact 23 of the relay 24 switches the “Class B” potential 12 through to the output terminal 7.

Via a further floating contact 22, optionally a positively driven break contact, the state of the relay 24 is fed back via the feedback channel 10 to the safe logic module 4.

“Positive driving” of contacts means optionally that the contacts are embodied mechanically in a form such that the break contact and the make contact cannot simultaneously be closed even in a fault situation.

With reference to FIG. 3, a wiring diagram of a third exemplary implementation of the system having a distribution apparatus and a safety module is explained. This is based on the description above of the first and second exemplary implementations, and elements which are similar or have the same effect, or are structurally and/or functionally comparable, are provided with the same references. The differences between the exemplary implementations are primarily discussed below.

In the third exemplary implementation of a system 30, redundant floating contacts are provided. An IO-Link takes place with floating contacts.

The DC isolation is produced in this exemplary implementation via two optocouplers 39, 49 and a plurality of floating contacts of a plurality of relays 31, 41. The optocouplers 39, 49 are connected for driving respectively via an output drive line 11, 34 to the device safe logic module 4.

Instead of a double optional implementation, a further multiple optional implementation may also be envisioned for further increased redundancy.

The driving and feedback take place in a similar way to the second exemplary optional implementation of the safety module 20 described above with reference to FIG. 2.

In this exemplary optional implementation, however, the floating contacts 32, 42 are routed to terminals 35, 36, 37, 38, to which a voltage can be externally applied. Optionally, the contacts 32, 42 are configured as makers while the contacts 33, 43 are configured as breakers.

The secure disabling of the two relays takes place as described above.

In order to achieve secure disabling on the contact side, a plurality of contacts may be functionally usable with one another so that redundant disabling is produced.

To summarize briefly, the disclosure is based inter alia on the idea of providing secure disabling of the electrical device by redundant disabling paths being divided between a safety module and a distribution apparatus. That is to say, an electrical device having a safety module may be configured optionally so that it only has one securely diagnosable disabling path and it induces disabling by the distribution apparatus in a fault situation.

### LIST OF REFERENCE CHARACTERS

1 system
2 safety module (on the side of a FS device)
3 distribution apparatus; FS master
4 device safe logic module
5 disabling component (of the FS master)
6 switching module; “safety output” module
7 positive output pin
8 negative output pin
9 external voltage supply
10 line (feedback)
11 output drive line
12 line (Class B positive)
13 line (Class B negative)
14 second optocoupler (for feedback)
15 first optocoupler (for output)
16 master safe logic module
20 system
21 optocoupler (for relay drive)
22 feedback contact (positively driven)
23 output contact
24 relay
30 system
31 relay
32 contact (make)
33 contact (break)
34 output drive line
35 terminal
36 terminal
37 terminal
38 terminal
39 optocoupler (for relay drive)
41 relay
42 contact (make)
43 contact (break)
49 optocoupler (for relay drive)
50 electrical device; FS device
51 electrical device
52 electrical device

What is claimed is:

1. A safety module for an electrical device, comprising:
a device power input configured to be electrically connected to an electrical distribution apparatus;
a device power output configured to be connected to the electrical device;
a switching module configured to switch an electrical connection between the device power input and the device power output;
a device safe logic module configured to drive the switching module; and
a device interface configured to establish a data-technological connection of the device safe logic module to the electrical distribution apparatus;
wherein the device safe logic module is configured to monitor a switching state of the switching module and, when a fault state of the switching module occurs, to send a disabling signal via the device interface to the electrical distribution apparatus.

2. The safety module as claimed in claim 1, wherein the device interface is configured to establish an IO-Link connection.

3. The safety module as claimed in claim 1, wherein a voltage supply of the device safe logic module is galvanically isolated from the device power input.

4. The safety module as claimed in claim 1, further comprising at least one optocoupler, inductive coupler and/or capacitive coupler.

5. The safety module as claimed in claim 4, wherein the at least one optocoupler, inductive coupler and/or capacitive coupler is/are configured to produce a galvanic isolation between a potential applied to the device power input and a potential for a voltage supply of the device safe logic module.

6. The safety module as claimed in claim 1, wherein the switching module includes a semiconductor switch and/or a relay switch and/or a contactor and/or a mechanical switch with a positively driven contact.

7. The safety module as claimed in claim 1, wherein the switching module includes precisely one disabling path.

8. The safety module as claimed in claim 1, wherein the switching module includes a feedback path being provided for the switching state of the switching module.

9. An electrical device comprising a safety module according to claim 1.

10. A distribution apparatus for providing a voltage supply for at least one electrical device, comprising:
a master power output;
at least one disabling component configured to disconnect the master power output;
a master safe logic module configured to drive the disabling component; and
a master interface configured for data-technological connection of the master safe logic module to a safety module assigned to the electrical device;
wherein the master safe logic module is configured to drive the disabling component when a disabling signal is received so that the master power output is disconnected.

11. A system comprising an electrical distribution apparatus and the safety module according to claim 1, wherein the device power input is electrically connected to the electrical distribution apparatus; and the device interface establishes a data-technological connection of the device safe logic module to the electrical distribution apparatus.

12. A method comprising operating a system having an electrical device which is coupled for voltage supply via a safety apparatus to a distribution apparatus; wherein operating the system includes switching a voltage supply via the safety apparatus; monitoring a switching state of the safety apparatus; and, when a fault state occurs, sending a disabling signal to the distribution apparatus causing the distribution apparatus to switch the voltage supply.
